(19) United States
(12) Patent Application Publication
(10) Pub. No.: US 2006/0280864 A1
(43) Pub. Date: Dec. 14, 2006

(54) Method for electrode deposition for solid oxide fuel cells

(76) Inventors: Toshio Suzuki, Nagoya (JP); Piotr Jasinski, Gdansk (PL); Vladimir Petrovsky, Rolla, MO (US); Harlan Anderson, Rolla, MO (US); Xiao-Dong Zhou, Rolla, MO (US)

Correspondence Address: KENYON & KENYON LLP, ONE BROADWAY, NEW YORK, NY, 10004, US

(21) Appl. No.: 11/150,394

(22) Filed: Jun. 9, 2005

(51) Int. Cl. B05D 1/12; B05D 3/02; B05D 1/40

(52) U.S. Cl. 427/180; 427/372.2; 427/331

(57) ABSTRACT

The present invention relates to methods for the preparation of electrodes for use in solid oxide fuel cells. More specifically, the present invention relates to methods for the preparation of ceramic electrodes that provide high ionic and electronic conduction, high porosity and high surface area. Additionally, the methods of the invention allow for controlled and optimized properties of ionic and electronic phases for a particular operating condition. Advantageously, the methods of the invention allow for the fabrication of SOFC electrodes using low processing temperatures and inexpensive techniques requiring no specialized equipment.

### FIELD OF THE INVENTION

The present invention relates to methods for the preparation of electrodes for use in solid oxide fuel cells. More specifically, the present invention relates to methods for the preparation of ceramic electrodes that provide high ionic and electronic conduction, high porosity and high surface area.

### BACKGROUND

A fuel cell converts chemical energy directly into electrical energy without using chemical combustion, giving much higher conversion efficiencies and low emissions. In one form of such a fuel cell, an anode layer and a cathode layer are separated by an electrolyte formed of a ceramic oxide. Such a fuel cell is known as a “solid oxide fuel cell” (SOFC). A single SOFC unit consists of two electrodes (an anode and cathode) separated by an electrolyte. An electrical current is produced by electrochemically reacting a gaseous fuel (e.g., hydrogen, methane, CO) with an oxidant (e.g., oxygen, air) across an oxide electrolyte. At the anode, the fuel reacts with oxygen ions from the electrolyte releasing electrons to the external circuit. On the other side of the fuel cell, oxidant is fed to the cathode, where it supplies the oxygen ions (O₂—) for the electrolyte by accepting electrons from the external circuit. The electrolyte conducts these ions between the electrodes, maintaining overall electrical charge balance. The flow of electrons in the external circuit provides useful power.

The SOFC, with its solid state components, in principle may be constructed in any configuration. Cells are typically of planar or tubular construction and comprise layers of metal oxide ceramics which form the electrodes and electrolyte layers of the SOFC. The SOFC electrolyte is a ceramic membrane, often yttrium stabilized zirconia (YSZ) having the formula (ZrO₂)₁₋ₓ(YO_{1.5})ₓ. The electrodes are porous, conducting metal-ceramics, such as Sr doped LaMnO₃, La₁₋ₓSrₓMnO₃ (LSM), La₁₋ₓSrₓCo_{y}Fe_{1-y}O₃ (LSCF), or NiZrO₂ cermet.

Ceramic materials are commonly prepared from metal oxide powders, such as zirconia, ceria, titania, and alumina using a variety of methods including tape casting, screen printing, spinning, dipping or spraying. Each of these methods go through what is referred to as “green ceramic.” At this stage, the aggregate structure of the ceramic material is formed, but the porosity of the material is high, ranging from about 30% to about 50%, and the connection between the particles in the material is poor. Green ceramic is subjected to treatment with high heat (generally ½ to ¾ of the melting point) in a process known as sintering to convert the green ceramic into a cohesive “fired ceramic” having a nearly monolithic polycrystalline phase. The disadvantage of this process is the necessity of a high heat treatment to densify the green ceramic. Additionally, shrinkage typically occurs during the sintering process.

Prior techniques for the deposition of electrodes in SOFCs are based on mixing powders of the ionic phase (typically, an electrolyte material) and the electronic phase (an electronically conducting or mixed conducting material) with some addition of pore forming material (i.e. carbon). This mixture is deposited on the electrolyte layer and sintered at a high temperature, typically above 1000° C. The high temperature sintering ensures good connection between the electrolyte and the electrode as well as between the two phases within the electrode.

This approach has at least two serious limitations. The volume ratio between the two phases (e.g., electrolyte material and conducting material) in the electrode is typically limited to about 30 to 60 vol % to ensure effective connection between the particles of both phases, so there is limited freedom in the composition of the electrode material, and optimization of the particular operating conditions is difficult. In addition, the sintering temperature needs to be high enough to sinter the particles of each phase together and ensure both good ionic and electronic conductivity of the electrode material. The high temperature limits the number of materials which can be used for the electrode preparation because of possible reaction between materials of ionic and electronic phases during sintering. The grain size in both the electrolyte and the electronically conductive phases will increase during the sintering process, so the effective reaction surface area will be decreased, limiting the efficiency of the electrode.

The ceramic electrodes (anode and cathode) are important parts of the solid oxide fuel cells and the overall performance of the cell may be compromised if the properties of the electrode are not optimized.

### SUMMARY OF THE INVENTION

The present invention provides methods for preparing layers of metal oxide ceramics, which form the electrodes and electrolyte layers of SOFCs. In one aspect of the invention, there is provided a method of preparing a ceramic electrode layer on a substrate comprising the steps of (a) depositing a powder of the ionic phase onto a substrate, (b) bonding the powder of the ionic phase, and (c) coating the electrode layer with an electronically conducting material. The coating (c) comprises treatment with a metal-organic polymer followed by heat treatment at a preferred temperature of about 200° C. to about 800° C.

The present invention also provides a method of preparing a metal oxide thin film on a substrate. A suspension of a powdered metal oxide is prepared comprising a metal oxide powder, a metal-organic polymer, and a solvent. The suspension of the powdered metal oxide is applied to a substrate to give a layer of the metal oxide. The layer of the metal oxide is treated with a solution of a metal-organic polymer and heated at a preferred temperature of less than about 1100° C. to give the metal oxide thin film.

### BRIEF DESCRIPTION OF THE FIGURES

FIG. 1 shows a thin film electrolyte of yttrium doped zirconia (YSZ) on (a) a porous (La, Sr)MnO₃ cathode substrate after coating with metal-organic polymer and annealing at 900° C., and (b) YSZ thin film (2 mm) on an Ni—YSZ anode substrate.

FIG. 2 shows the preparation of a composite interlayer by the steps of spin coating a suspension of YSZ onto an LSM cathode, coating with SrSmCo polymer precursor, and spin coating colloidal YSZ and YSZ polymer precursor.

FIG. 3(a) show the effects of Sm_{0.5}Sr_{0.5}CoO polymer coating in the YSZ layer prepared on a dense substrate. FIG. 3(b) shows a cross section of the YSZ-interlayer-porous substrate.

FIG. 4 shows the impedance spectra for the symmetrical cell (SSC/YSZ/SSC) for several temperatures in air.

### DETAILED DESCRIPTION

The present invention provides methods for the deposition of electrodes for solid oxide fuel cells. The method of the invention provides high ionic and electronic conduction, high porosity for effective gas diffusion, and high surface area for effective reaction. Additionally, the methods of the invention allow for controlled and optimized properties of ionic and electronic phases for a particular operating condition. Advantageously, the methods of the invention allow for the fabrication of SOFC electrodes using low processing temperatures and inexpensive techniques requiring no specialized equipment.

The present invention also provides a method of preparing a metal oxide thin film on a substrate by applying a suspension of a powdered metal oxide to a substrate to give a layer of the metal oxide, treating the layer of the metal oxide with a solution of a metal-organic polymer, and heat treatment, preferably at a temperature of less than about 1000° C., to give the metal oxide thin film. The suspension of the powdered metal oxide comprises a metal oxide powder, a metal-organic polymer, and a solvent.

The SOFC electrodes are multifunctional layers which may be characterized by high porosity, high effective surface area and two-phase design. Electrode layers should be porous (have open porosity) to ensure effective gas penetration through the layers up to the surface of the dense electrolyte.

The electrode layer or layers comprise(s) two phases which allows for a high rate of gas to oxygen ion exchange. The first phase is a material with high ionic conductivity (ionic phase). The function of this phase is to collect and deliver the oxygen ions to the surface of the electrolyte (cathode side) or to the reaction points (anode side). The particles (or grains) of this phase need to be well connected to ensure effective oxygen ion conduction. The second phase is an electronic or mixed conductor (electronic phase). The function of this phase is to collect the electrons generated by the reaction between the fuel and oxygen ions and deliver them to the surface of the electrode where anode metal current collectors are positioned (anode side) or to transfer the electrons from cathode metal current collectors to the reaction point (cathode side). The particles (or grains) of this phase need also to be well connected to ensure effective electron conduction.

Preferred material for the ionic phase include stabilized ZrO₂ (Y, Sc, Ca, etc.), doped CeO₂ (Gd, Sm, Y, etc.), doped LaGaO₃, and the like. In a preferred embodiment, the material selected for the ionic phase is same as selected for the electrolyte.

The electronic phase for the anode is preferably selected from metals (such as Pt, Ni, Pd, Cu, Au, Ag, Ru, etc.) and electronic conductive ceramics that are stable in a reducing atmosphere, such as doped SrTiO₃. Ni is particularly preferred as the electronic phase for the anode.

The electronic phase for the cathode is preferably selected from metals (such as Pt, Au, Pd, etc.) and electronic conductive ceramics, such as SmCoO₃ doped with Sr, LaMnO₃ doped with Sr, and LaFeO₃ doped with Sr and/or Co.

The grain size of both phases needs to be small enough to increase the effective surface area between the phases and to decrease the reaction over potentials (so called triple boundary problem). The preferred range of grain sizes for the ionic phase is about 10 μm to about 10 nm and for the electronic phase is about 1 μm to about 5 nm.

In a preferred embodiment, the method of the present invention comprises the following steps:

(a) The powder of the ionic phase (electrolyte) is deposited on a substrate, such as a presintered electrolyte, by any known technique to form a 1 to 100 μm thick porous ceramic layer (green ceramic layer). Deposition techniques include spin coating with a suspension or slurry of the powder of the ionic phase in a suitable solvent, although other deposition techniques known in the art may be used. This step serves to form a porous body of the electrode with a desired thickness.

(b) The powder of the ionic phase is bonded, which serves to connect the particles of the green ceramic layer together without densification of the material. The bonding of the ionic phase powder may be accomplished by low temperature sintering or by impregnating the initial electrode layer with metal-organic polymer. The low temperature sintering is preferably performed at a temperature of about 600° C. to about 1200° C., and more preferably about 800° C. to about 1000° C. If a metal-organic polymer is used to coat the initial electrode layer, the metal-organic polymer preferably has the same metal oxide composition as an electrolyte material used to form the initial electrode layer. Subsequently, the organic content of the polymer may be removed by heating at a low temperature, preferably about 200° C. to about 800° C., and more preferably about 200° C. to about 400° C. The bonding of the ionic phase promotes effective oxygen ion conduction and collection in the electrode.

(c) The electrode layer is impregnated with an electronically conducting (or mixed conducting) material by using a metal-organic polymer with the proper metal or metal oxide composition layer. Subsequently, the organic content of the polymer is removed by heating at a low temperature. Coating the electrode layer with an electronically conducting material serves to introduce high electron conduction in the electrode layer and to form high surface area interface between the two (ionic and electronic) phases. The electronically conducting material may be a mixed conducting material.

The electrode layers prepared by the method of the invention have both high ionic and electronic conduction. It also will have high porosity to ensure effective gas exchange in the electrode layers. The electrode prepared by this method will have high effective reaction surface area, because of the low sintering temperature, and consequently, the particle size of both the ionic and electronic phases will be minimal. Reaction between these two phases may be minimized by avoiding the use of high temperature sintering. As a result, there a wider range of material may be used in the electrode design. In a preferred embodiment of the invention, steps 1 to 3 are performed separately, which makes it possible to control and optimize properties of both ionic and electronic phases for particular operation conditions.

In one embodiment of the invention, a colloidal suspension of a powdered metal oxide is initially prepared. The colloidal suspension comprises powdered metal oxide, metal-organic polymer, and solvent. Preferably, the composition of the metal oxides of the powdered metal oxide and the metal-organic polymer are the same. In a preferred embodiment, the ratio for the metal oxide powder and the metal-organic polymer are about 1:1 (by weight). The colloidal suspension is applied to a target, for example by spin coating to give a thin film. The target may be a dense or porous substrate, such as an electrolyte layer. The coating is dried and heated to a temperature sufficient for bonding to the surface. The incorporation of the metal-organic polymer in the suspension of the metal oxide powder provides bonding between the particles of the metal oxide and between the metal oxide and the target. The layer formed may be further treated with one or more applications of the solution of metal-organic polymer with subsequent heating to achieve the desired density or composition of the final film. The processing temperature is preferably under about 1000° C. The minimum processing temperature may be determined by the crystallization temperature for electronic conducting materials. Preferred processing temperatures are from about 400° C. to about 800° C., and more preferably from about 600° C. to about 800° C.

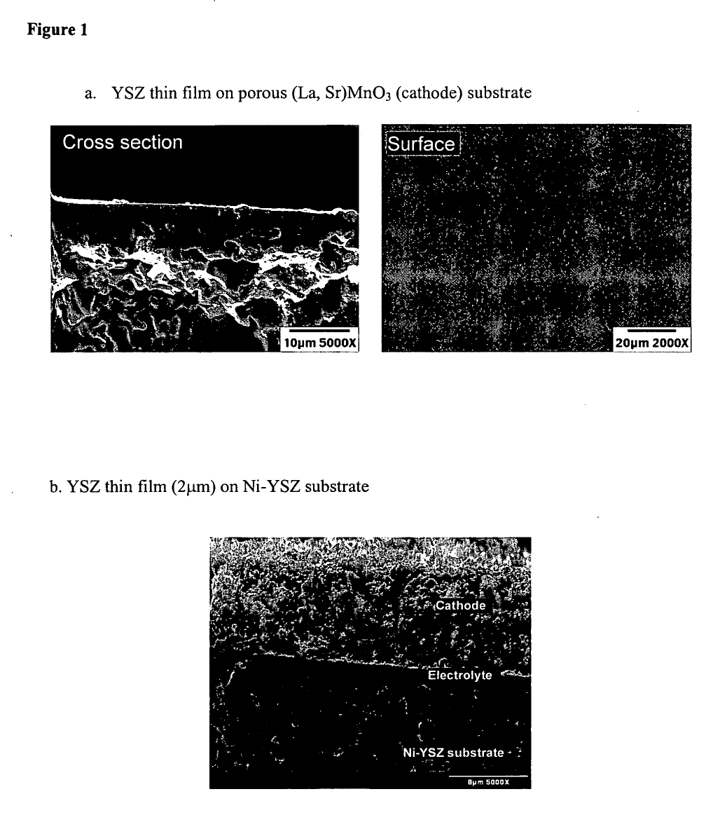

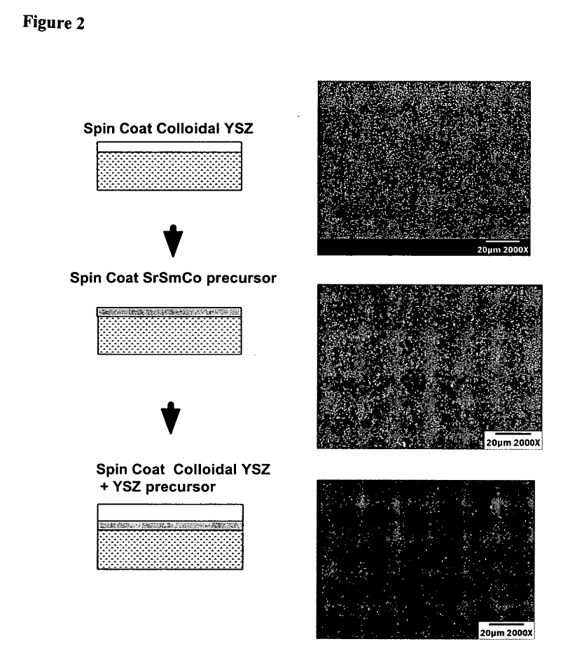

The method of the invention may be used to deposit an anode or cathode onto an electrolyte layer. In another embodiment, the above method may be used to deposit a thin film electrolyte onto an electrode (such as in FIG. 1(a) and 1(b)), or to provide interfacial layers between an electrode and electrolyte (FIG. 2). For example, a thin film electrolyte of yttrium doped ZrO₂ (YSZ) may be deposited on a porous (La, Sr)MnO₃ cathode substrate or on a Ni—YSZ substrate.

An electrode may be prepared on any electrolyte, including, for example, composite electrolytes prepared by the method of the invention. For example, a suspension of an anode material, such as a Ni-cermet suspension, may be applied onto an electrolyte layer. The layer is treated with a solution of a metal-organic polymer, for example, Ni-containing metal oxide polymer, followed by heat treatment at a temperature under about 1000° C.

In another embodiment of the invention a suspension of a cathode material is applied onto an electrolyte. The layer of cathode material is treated with a solution of a metal-organic polymer followed by heat treatment under about 1000° C.

The initial metal oxide powder may be selected from, for example, an oxide of aluminum, silicon, zirconium, cerium, titanium, yttrium, samarium, gadolinium, lanthanum, praseodymum, calcium, chromium, manganese, iron, cobalt, nickel, copper, niobium, hafnium, molybdenum, tantalum, tungsten and a mixture thereof. The metal oxide may be any combination of materials such as doped ZrO₂, doped CeO₂, Ni-cermet, a rare earth-CoO₃, a rare earth-MnO₃, a rare earth-FeO₃, or the like.

The term porous metal oxide ceramic material as used herein refers to any metal oxide ceramic material or precursor that is not fully dense and includes, for example green ceramic materials.

“Metal-organic polymer” as used herein refers to any organic composition which contains a metal cation, or different metal cations, incorporated in the organic composition. The metal-organic polymer provides a coating on the metal oxide particles and decomposes to form an amorphous or nanocrystalline metal oxide (or metal oxides) at relatively low processing temperatures.

Metal-organic polymers, also referred to as metal oxide polymers, are well known materials. These materials can be prepared from metal-alkoxides, from metal salts using the process described for example in U.S. Pat. No. 5,494,700, which is incorporated herein by reference in its entirety, or by a variety of the other methods. In one embodiment, the metal-organic polymer is prepared from the corresponding metal alkoxide which is polymerized by the addition of water, ethylene glycol, or the like. Use of the metal alkoxide as the precursor results in a metal-organic polymer having a high metal content and a decomposition temperature (for example, about 200° C. to about 400° C.). However, such metal-organic polymers generally suffer from sensitivity to moisture. It is also possible to prepare the metal-organic polymers from the salts of corresponding metals and use different organic materials (for example, ethylene glycol, citric acid, etc.) for substitution reactions and further polymerization. Acetates of metals are well known precursors for such processing. This processing may be advantageous as acetates of different metals are widely available, it is relatively easy to polymerize metal acetates, and the resulting metal-organic polymers are stable and not generally sensitive to moisture. In many cases, this type of polymer may be prepared as the water solution. However, these polymers typically have a lower metal content and higher decomposition temperature (from about 300° C. to about 500° C.) as compared to metal-organic polymers prepared from metal alkoxides. A preferred method for preparing the metal-organic polymer is from the elementary salt (such as nitrates, chlorates, etc.) as described in U.S. Pat. No. 5,494,700 to Anderson et al., which is incorporated herein by reference in its entirety. Although substitution and polymerization processes may be more complicated in this case, polymeric metal oxides for a series of metals may be prepared by this method. The resulting metal-organic polymers have a relatively high metal content, low decomposition temperatures and are generally water-compatible.

A metal-organic polymer can be deposited using, for example, spin on deposition, dip coating or spraying, and is thereafter converted to a dense amorphous or nanocrystalline metal oxide film by decomposing the organic content of the polymer at temperatures under about 1000° C. Preferably, the sample is heated to a temperature of less than about 800° C. The films of different metal oxides can be prepared by this technique including, for example, zirconia, ceria, titania, etc., as well as various metal oxide compositions including, for example, yttrium doped zirconia (YSZ), gadolinium and samarium doped ceria (GDC and SDC), barium titanate (BT), strontium titanate (ST), etc.

The solvents employed in the methods of the invention may be selected from any solvent or mixture of solvents that is compatible with the metal-organic polymer. Preferred solvents include water, alcohols (such as methanol, ethanol, butoxyethanol, and the like), and mixtures thereof. The solvent may be removed, for example by evaporating at room temperature or at an elevated temperature prior to the subsequent processing step.

Upon treatment with the metal-organic polymer, the metal-organic polymer will coat the particles of metal oxide or fill the pores between the particles in the initially porous ceramic material. The metal-organic polymer is subsequently converted into an amorphous or nanocrystalline metal oxide by decomposition of the polymer at the heat treatment stage of the process. The decomposition of the metal-organic polymer is achieved by heat treatment at relatively low temperature. The impregnated ceramic material is heated at temperatures under about 1100° C. In one embodiment, the impregnated ceramic material is heated at a temperature of about 200° C. to about 800° C. Preferably, the decomposition temperature is from about 200° C. to about 500° C., and more preferably from about 200° C. to about 400° C. The metal-organic polymer is unlikely to decompose at temperatures lower than 200° C., unless the material is concurrently treated with an additional means of assisting the decomposition, such as UV-radiation, γ-radiation, etc. Although a decomposition temperature of about 200° C. to about 400° C. is preferred, for some metal-organic polymers a decomposition temperature higher than 400° C. is needed (for example, for hard connected organic materials). Without being limited by theory, it is believed that the low decomposition temperatures is effective because the metal oxide that is prepared has no phase transitions, so that a final stable phase can be achieved at low temperature. However, this may not hold for all materials. For titania, the decomposition temperature may be higher than about 900° C. (the transition temperature for the rutile phase) and for alumina it may be higher than 1100° C. (the transition temperature for the corundum phase). At the decomposition stage of the process, an amorphous or nanocrystalline metal oxide layer forms on the particle surface. This layer increases the particle size of ceramic material and, consequently, decreases the porosity. As the organic content of the polymer is decomposed by heating at a low temperature, an amorphous or nanocrystalline metal oxide layer forms on the particle surface.

The present invention allows the composition and the density of the final ceramic material to be controlled by adjusting the metal oxide content in the metal-organic polymer, or by repeating the application of the metal-organic polymer multiple times until the desired density is achieved. Thus, this methods can be used to decrease the porosity of the initially porous ceramic material, if metal-organic polymer has the same metal oxide composition as the initial ceramic material. It also can be used to build composite materials if metal oxide compositions in the metal-organic polymer and in the initial ceramic material are different. The final porosity and the composition of the ceramic material can be controlled by changing the metal oxide content in the polymer, or by repeating proposed process for several times.

### EXAMPLES

### Example 1

### Preparation of a Composite Interlayer Plus Electrolyte (FIG. 2)

Sm_{0.5}Sr_{0.5}Co₀₃ (SSC) polymer was prepared using samarium nitrate, strontium nitrate and cobalt nitrate by the following procedure. Samarium nitrate (0.01 mol), strontium nitrate (0.01 mol) and cobalt nitrate (0.02 mol) were dissolved in water (30 g) and 2 g of 70% nitric acid was added to the solution. Ethylene glycol (1 mol) was mixed with the resulting solution and the mixture was heated with stirring at 250° C. for about a half hour. Alternatively, water may be evaporated to provide polymerization. The polymer appeared as a viscous, dark brown liquid without precipitation. The final SSC polymer solution was prepared by adding 1 to 1 volume fraction of butoxyethanol.

16%Y ZrO₂ (YSZ) polmer was prepared using yttrium nitrate and zirconium chlorate by the following procedure. Yttrium nitrate (0.0064 mol) and zirconium dichloride oxide (0.0336 mol) were dissolved in water (30 g). Ethylene glycol (1 mol) was mixed with the resulting solution and the mixture was heated with stirring at 70° C. for 24 hours to evaporate water and provide polymerization. The polymer appeared as a viscous, transparent liquid without precipitation. The final YSZ polymer solution was prepared by adding 1 to 1 volume fraction of butoxyethanaol.

A slurry was prepared by mixing YSZ powder (25 g) with water and butoxyethanol (50 g). The average particle size of YSZ powder was 100 nm. The slurry was homogenized by treatment using a 130 Watt ultrasonic processor VC 130 (Sonics & Materials, Inc.) for 3 hours.

The slurry was deposited on an LSM substrate by spin coating (spinner speed 1000 rpm, spinning time 30 s) and dried at 70° C. and 150° C. for half an hour to evaporate the solvent. Then the SSC polymer solution was deposited on the surface of the coating by spin coating (spinner speed 3000 rpm, spinning time 30 s) and dried at 70° C. for half an hour and heated up from 70° C. to 400° C. (10° C./min) to decompose the polymer, followed by cooling to room temperature. This deposition procedure was repeated 8 times.

After the SSC coating procedure, the slurry was again deposited on this surface of the sample by spin coating at the speed of 1000 rpm for 30 s and dried at 70° C. and 150° C. for half an hour. Then the YSZ polymer solution was deposited on the surface of the coating by spin coating (spinner speed 3000 rpm, spinning time 30 s) and dried at 70° C. for half an hour and heated up from 70° C. to 400° C. (10° C./min) to decompose the polymer, followed by cooling to room temperature. This deposition procedure was repeated 20 times.

### Example 2

The slurry from Example 1 was deposited on a dense substrate by spin coating (spinner speed 1000 rpm, spinning time 30 s) and dried at 70° C. and then 150° C. for half an hour each. Then the SSC polymer solution was deposited on the surface of the coating by spin coating (spinner speed 300 rpm, spinning time 30 s) and dried at 70° C. for half an hour and heated up from 70° C. to 400° C. (10° C./min) to decompose the polymer, followed by cooling to room temperature. This deposition procedure was repeated 3-8 times. Finally, this sample was sintered at 800° C. for an hour.

Characterization of the Electrode

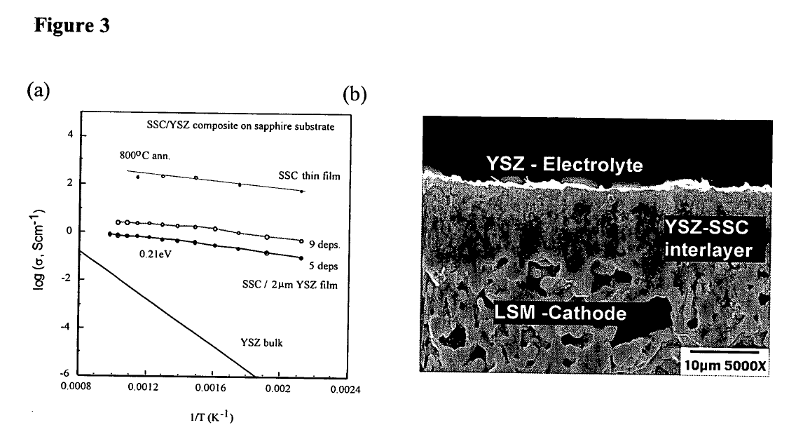

FIG. 3(a) shows the effect of SSC polymer coating in the YSZ layer prepared on a dense substrate. Conductivity of the electrode increased as the number of coating increased.

### Example 3

### Preparation and Characterization of the Symmetrical Cell

The slurry from Example 1 was deposited on the YSZ substrate (as an electrolyte) by spin coating (spinner speed 1000 rpm, spinning time 30 s) and dried at 70° C. and then 150° C. for half an hour each. Then the SSC polymer solution was deposited on the surface of the coating by spin coating (spinner speed 300 rpm, spinning time 30 s) and dried at 70° C. for half an hour and heated up from 70° C. to 400° C. (10° C./min) to decompose the polymer, followed by cooling to room temperature. This deposition procedure was repeated 8 times. This procedure was also applied for the other side of substrate to prepare a symmetrical cell. Following the coating procedure, this sample was sintered at 800° C. for one hour.

Characterization of the Symmetrical Cell

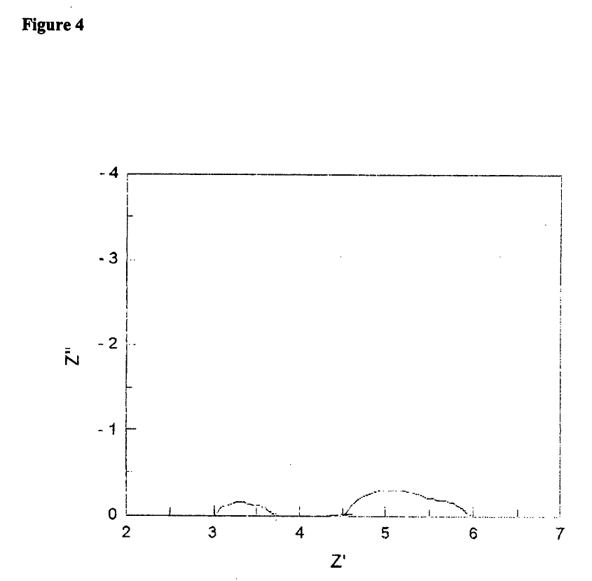

The symmetrical cell (SSC/YSZ/SSC) was investigated using a Solartron 1470 Battery Tester and 1255B Impedance Gain Phase Analyzer. Silver was used as a current collector over the temperature range of 500-800° C. FIG. 4 shows the impedance spectra for the symmetrical cell for several temperatures. The overpotential of this cell is very small, showing excellence of this composite electrode.

What is claimed is:

1. A method of preparing a metal oxide thin film on a substrate comprising:
preparing a suspension of a powdered metal oxide comprising
a metal oxide powder,
a metal-organic polymer, and
a solvent;
applying the suspension of the powdered metal oxide to a substrate to give a layer of the metal oxide;
treating the layer of the metal oxide with a solution of a metal-organic polymer; and heat treatment at a temperature of about 200° C. to about 1000° C. to give the metal oxide thin film.

2. The method of claim 1, wherein the powdered metal oxide is selected from an oxide of aluminum, silicon, zirconium, cerium, titanium, yttrium, samarium, gadolinium, lanthanum, praseodymum, calcium, chromium, manganese, iron, cobalt, nickel, copper, niobium, hafnium, molybdenum, tantalum, tungsten and a mixture thereof.

3. The method of claim 1, wherein the heat treatment is at a temperature of about 200° C. to about 800° C.

4. A method of preparing a ceramic electrode layer on a substrate comprising:
depositing a powder of the ionic phase onto a substrate;
bonding the powder of the ionic phase to give a bonded ionic phase; and
coating the bonded ionic phase with an electronically conducting material,
wherein the coating comprises treatment with an metal-organic polymer followed by heat treatment at a temperature of about 200° C. to about 1000.

5. The method of claim 4, wherein the bonding of the ionic phase is by low temperature sintering at a temperature below about 1200° C.

6. The method of claim 5, wherein the bonding of the ionic phase is by low temperature sintering at a temperature of about 800° C. to about 1000° C.

7. The method of claim 4, wherein the bonding of the ionic phase is by coating the ionic phase with a metal-organic polymer.
